(19) United States
(12) Patent Application Publication
(10) Pub. No.: US 2026/0219827 A1
(43) Pub. Date: Jul. 30, 2026

(54) IMAGE DISPLAY APPARATUS AND IMAGE DISPLAY SYSTEM

(71) Applicant: SEIKO EPSON CORPORATION, Tokyo (JP)

(72) Inventors: Naoki ISHII, MATSUMOTO-SHI (JP); Kazumi YOSHIZAWA, MATSUMOTO-SHI (JP)

(21) Appl. No.: 19/463,634

(22) Filed: Jan. 29, 2026

(30) Foreign Application Priority Data
Jan. 30, 2025 (JP) 2025-013899

(51) Int. Cl. G06F 3/14

(52) U.S. Cl. CPC G06F 3/1423

(57) ABSTRACT

A projector includes a projection device, a power supply device, a communication device, a first processing device configured to control the power supply device, a second processing device configured to control the projection device, and a third processing device configured to control the communication device. The communication device includes a first input/output IF and a second input/output IF. The third processing device executes detecting that a computer that outputs image data has been connected to the first input/output IF, acquiring the image data output by the computer, and outputting the image data from the second input/output IF to a display.

The present application is based on, and claims priority from JP Application Serial Number 2025-013899, filed January 30, 2025, the disclosure of which is hereby incorporated by reference herein in its entirety.

### BACKGROUND

### 1. Technical Field

The present disclosure relates to an image display apparatus and an image display system.

### 2. Related Art

There is known a display system in which a plurality of projectors or displays are connected to source equipment to display a video. For example, JP-A-2020-182049 discloses a display system in which source equipment, a first projector, and a second projector are connected in a daisy chain. That is, in the display system of JP-A-2020-182049, the source equipment and the first projector are connected to each other and the first projector and the second projector are connected to each other.

JP-A-2020-182049 is an example of the related art.

However, in the technology according to JP-A-2020-182049, the source equipment and the second projector are not directly connected. A processing device of the first projector plays a role of acquiring image data from the source equipment and outputting the image data to the second projector. Therefore, when a defect has occurred in the processing device of the first projector, a situation is likely to occur in which not only an image projected by the first projector but also an image projected by the second projector is not output.

### SUMMARY

According to an aspect of the present disclosure, there is provided an image display apparatus including: a projection device; a power supply device; a communication device including a first interface and a second interface; a first control circuit configured to control the power supply device; a second control circuit configured to control the projection device, the second control circuit being different from the first control circuit; and a third control circuit configured to control the communication device, the third control circuit being different from the first control circuit and the second control circuit, wherein the third control circuit executes: detecting that an image output apparatus that outputs image data was connected to the first interface; acquiring the image data output by the image output apparatus; and outputting the image data from the second interface to an external display apparatus.

According to an aspect of the present disclosure, there is provided an image display system including: source equipment; a first display apparatus connected to the source equipment; and a second display apparatus connected to the first display apparatus, wherein the second display apparatus outputs second specification information concerning display of an image by the second display apparatus to the first display apparatus, the first display apparatus outputs first specification information concerning display of an image by the first display apparatus and the second specification information to the source equipment, the source equipment determines, based on the first specification information and the second specification information, a format of image data displayable by the first display apparatus and the second display apparatus and outputs the image data in the determined format to the first display apparatus, and the first display apparatus outputs the image data to the second display apparatus.

According to an aspect of the present disclosure, there is provided an image display system including: source equipment; a first display apparatus connected to the source equipment, and a second display apparatus connected to the first display apparatus, wherein the second display apparatus outputs second specification information concerning display of an image by the second display apparatus to the first display apparatus, the first display apparatus generates third specification information based on first specification information concerning display of an image by the first display apparatus and the second specification information and outputs the third specification information to the source equipment, the source equipment determines, based on the third specification information, a format of image data displayable by the first display apparatus and the second display apparatus and outputs image data based on the third specification information to the first display apparatus, and the first display apparatus outputs the image data based on the third specification information to the second display apparatus.

### BRIEF DESCRIPTION OF THE DRAWINGS

FIG. 1 is a configuration diagram of an image display system according to a first embodiment.

FIG. 2 is a diagram illustrating a disposition example of elements in the image display system according to the first embodiment.

FIG. 3 is a block diagram illustrating a configuration example of a computer illustrated in FIG. 1.

FIG. 4 is a block diagram illustrating a configuration example of a projector illustrated in FIG. 1.

FIG. 5 is a block diagram illustrating a configuration example of a display illustrated in FIG. 1.

FIG. 6 is a sequence chart illustrating a power supply start operation of the projector illustrated in FIG. 1.

FIG. 7 is a sequence chart illustrating an image data output operation of the image display system illustrated in FIG. 1.

FIG. 8 is a sequence chart illustrating a power supply start operation of a projector according to a modification 1.

FIG. 9 is a sequence chart illustrating an image data output operation of an image display system according to a modification 2.

FIG. 10 is a sequence chart illustrating an image data output operation of an image display system according to a modification 3.

### DESCRIPTION OF EMBODIMENTS

A preferred embodiment according to the present disclosure is explained below with reference to the accompanying drawings. In the drawings, dimensions and scales of units are sometimes different from actual dimensions and scales, and there are also portions schematically illustrated in order to facilitate understanding. The scope of the present disclosure is not limited to the embodiment as long as there is particularly no description to the effect that the present disclosure is limited in the following explanation.

### 1. First Embodiment

### 1.1. Overview of an image display system

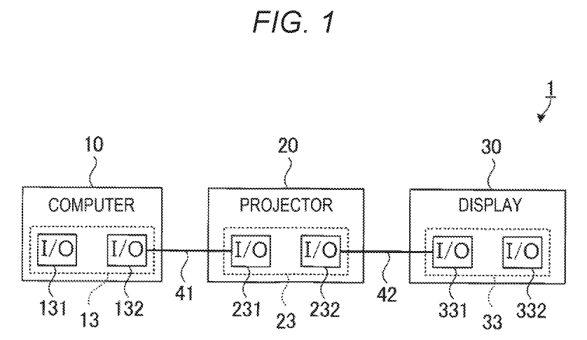

An overview of an image display system 1 according to a first embodiment is explained below with reference to FIGS. 1 to 7.

FIG. 1 is a configuration diagram of the image display system 1 according to the first embodiment. The image display system 1 includes a computer 10, a projector 20, and a display 30. The computer 10 includes a communication device 13. The communication device 13 includes a first input/output IF 131 and a second input/output IF 132. The projector 20 includes a communication device 23. The communication device 23 includes a first input/output IF 231 and a second input/output IF 232. The display 30 includes a communication device 33. The communication device 33 includes a first input/output IF 331 and a second input/output IF 332. Here, the first input/output IF 231 is an example of a first interface and the second input/output IF 232 is an example of a second interface.

The computer 10 and the projector 20 are connected to each other by a first communication cable 41. The projector 20 and the display 30 are connected to each other by a second communication cable 42. Therefore, the computer 10, the projector 20, and the display 30 are connected in a so-called daisy chain.

The first communication cable 41 and the second communication cable 42 are cables that transmit image data, a control signal, a notification signal, and a power supply voltage. For example, the first communication cable 41 and the second communication cable 42 are HDMI (registered trademark) cables.

The computer 10 stores first image data serving as a basis of a projection image projected by the projector 20 and second image data serving as a basis of a display image displayed by the display 30. The computer 10 transmits the first image data and the second image data to the projector 20.

More specifically, the first image data and the second image data output from the computer 10 are input to the projector 20 via the first communication cable 41. The first image data input to the projector 20 is stored in the storage device of the projector 20. The second image data input to the projector 20 is relayed by the projector 20 and input to the display 30 via the second communication cable 42.

When the computer 10 and the projector 20 are connected by the first communication cable 41, a connection notification signal is transmitted from the projector 20 to the computer 10. When the projector 20 and the display 30 are connected by the second communication cable 42, a connection notification signal is transmitted from the display 30 to the projector 20.

### 1.2. Disposition example of the image display system 1

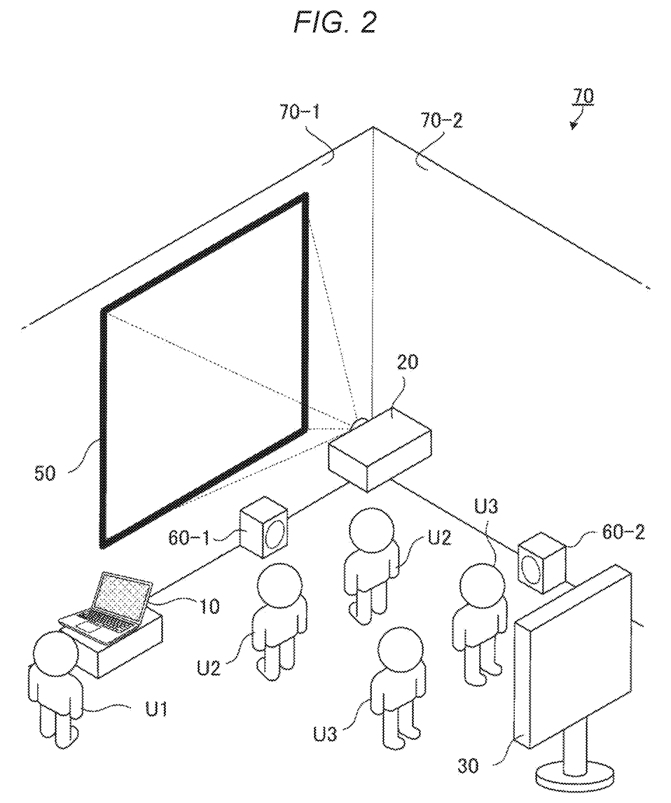

FIG. 2 is a diagram illustrating a disposition example of the elements in the image display system 1 according to the first embodiment. The elements in the image display system 1 are provided in a classroom 70. However, in FIG. 2, parts of a ceiling and wall surfaces in the classroom 70 are omitted in order to clearly explain the disposition example.

A screen 50 is disposed, for example, on a wall surface 70-1 in the front of the classroom 70. The projector 20 is installed on the ceiling of the classroom 70 and projects a video onto the screen 50. The display 30 is disposed in the back of the classroom 70. A speaker 60-1 is disposed on the wall surface 70-1 and a speaker 60-2 is disposed on a wall surface 70-2 on the right of the classroom 70.

A user U1 is, for example, a school teacher. The user U1 operates the computer 10 placed in the front of the classroom 70. Users U2 are, for example, a plurality of students belonging to a first group and users U3 are, for example, a plurality of students belonging to a second group. The users U2 belonging to the first group view first video content projected from the projector 20 onto the screen 50. The users U3 belonging to the second group view second video content displayed on the display 30.

In the present embodiment, the first video content and the second video content are the same content. In the present embodiment, it is assumed that specifications concerning image display of the projector 20 and specifications concerning image display of the display 30 are the same specifications. Therefore, in the present embodiment, the first image data and the second image data are the same image data.

### 1.3. Configuration of the computer 10

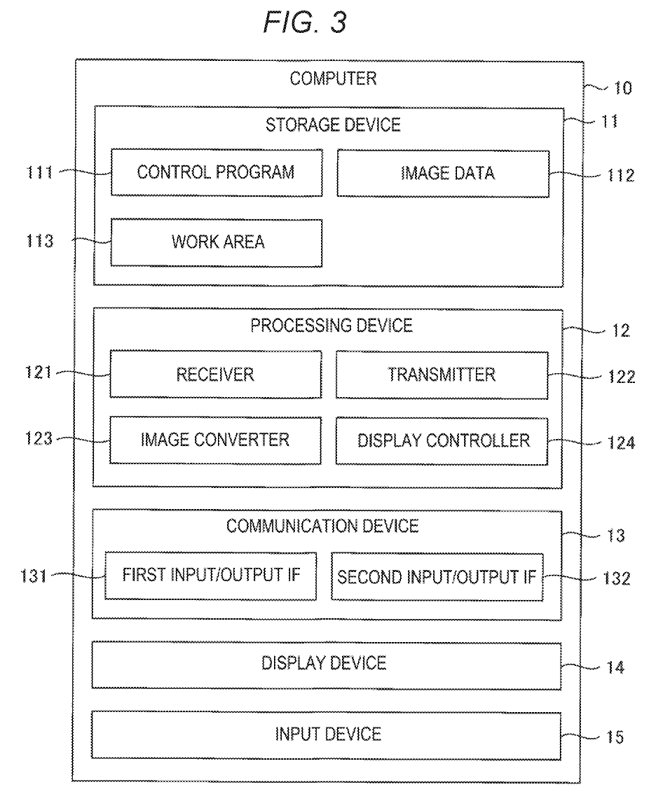

FIG. 3 is a block diagram illustrating a configuration example of the computer 10 illustrated in FIG. 1. The computer 10 includes a storage device 11, a processing device 12, a communication device 13, a display device 14, and an input device 15. The elements provided in the computer 10 are connected to one another by a single bus or a plurality of buses for communicating information. The computer 10 is an example of an image output apparatus and source equipment.

The storage device 11 stores various information. The storage device 11 includes a volatile memory such as a RAM and a nonvolatile memory such as a ROM. Here, RAM is an abbreviation for random access memory. ROM is an abbreviation for read only memory. A control program 111, image data 112, and the like are stored in the storage device 11. The volatile memory of the storage device 11 is used by the processing device 12 as a work area 113 of the processing device 12. The control program 111 is a program for controlling the entire computer 10.

A part or the entire storage device 11 may be provided in an external storage device, an external server, or the like. Some or all of the various information stored in the storage device 11 may be stored in the storage device 11 in advance or may be acquired from the external storage device, the external server, or the like.

The processing device 12 controls an operation of the computer 10. The processing device 12 has functions as a receiver 121, a transmitter 122, an image converter 123, and a display controller 124. The processing device 12 includes one or more CPUs. However, the processing device 12 may include a programmable logic device such as an FPGA or an ASIC instead of the CPU or in addition to the CPU. Here, CPU is an abbreviation for central processing unit, FPGA is an abbreviation for field-programmable gate array, and ASIC is an abbreviation for application specific integrated circuit.

The processing device 12 reads the control program 111 from the storage device 11 and executes the read control program 111. The processing device 22 functions as the receiver 121, the transmitter 122, the image converter 123, and the display controller 124 by executing the control program 111.

The receiver 121 receives, via the communication device 13, various signals output from the projector 20 and the display 30.

The transmitter 122 transmits the image data 112 to the projector 20 via the communication device 13.

The image converter 123 converts the resolution, the frame rate, and the like of the image data 112 according to necessity. For example, the image converter 123 converts image data formats such as the resolution and the frame rate of the image data 112 to match the specifications of the projector 20 or the display 30.

The display controller 124 controls the display device 14 to display an image or text.

The communication device 13 is hardware serving as a transmission and reception device for performing communication with other devices. The communication device 13 is also called, for example, network device, network controller, network card, or communication module. The communication device 13 may include a connector for wired connection and an interface circuit corresponding to the connector. The communication device 13 may include a wireless communication interface. Examples of the connector for wired connection and the interface circuit include products conforming to HDMI (High-Definition Multimedia Interface (registered trademark)), DisplayPort (registered trademark), wired LAN, IEEE1394, and USB. Examples of the wireless communication interface include products conforming to wireless LAN and Bluetooth (registered trademark). The communication device 13 performs data communication with the projector 20. In the present embodiment, HDMI (registered trademark) is explained as an example of the communication interface.

The display device 14 is a device that displays an image and character information. The display device 14 displays various images based on control of the processing device 12. For example, various display panels such as a liquid crystal display panel and an organic Electro Luminescence (EL) display panel are suitably used as the display device 14.

The input device 15 receives an operation from a user. For example, the input device 15 includes a pointing device such as a keyboard, a touch pad, a touch panel, or a mouse. Here, when the input device 15 includes the touch panel, the input device 15 may also serve as the display device 14.

### 1.4. Configuration of the projector

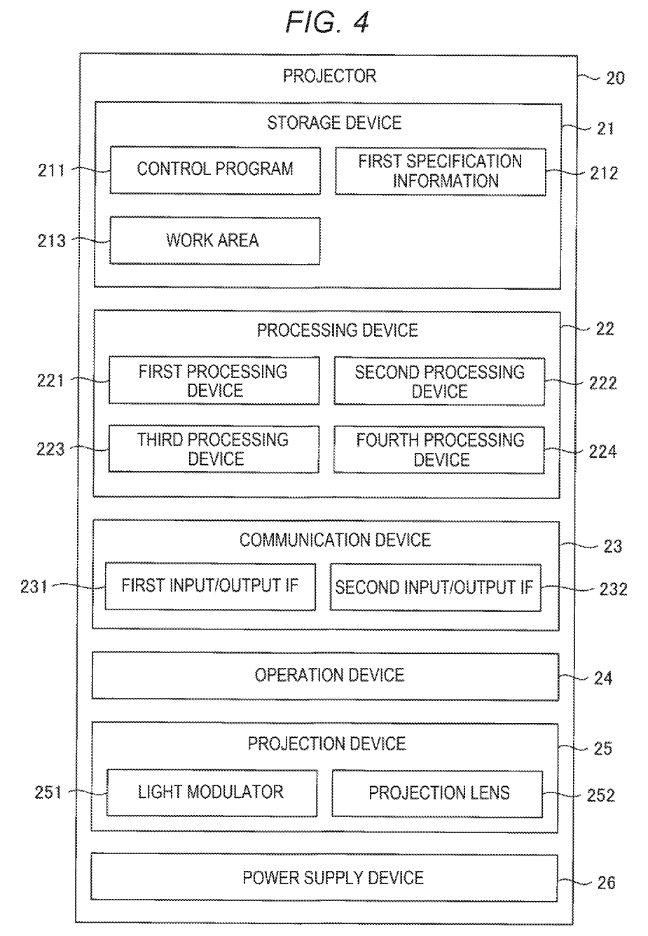

FIG. 4 is a block diagram illustrating a configuration example of the projector 20 illustrated in FIG. 1. The projector 20 includes a storage device 21, a processing device 22, a communication device 23, an operation device 24, a projection device 25, and a power supply device 26. The elements provided in the projector 20 are connected to one another by a single bus or a plurality of buses for communicating information. The projector 20 is an example of an image display apparatus and a first display apparatus.

The storage device 21 stores various information. The storage device 21 includes a volatile memory such as a RAM and a nonvolatile memory such as a ROM. A control program 211, first specification information 212, and the like are stored in the storage device 21. The volatile memory of the storage device 21 is used by the processing device 22 as a work area 213 of the processing device 22. The control program 211 is a program for controlling the entire projector 20. The first specification information 212 includes information concerning the resolution, the frame rate, the color depth, the color gamut, and the contrast of the projection device 25.

The resolution represents the number of pixels of an image displayed on the display device. As the resolution is higher, an image is higher in definition. The frame rate represents the number of frames per one second. As the frame rate is higher, a video is smoother. The color depth represents the resolution of an image per one pixel. The color depth is also referred to as deep color. As a numerical value of the color depth is larger, a video has a smoother change in a color. The color gamut indicates how wide a color range can be treated. As a standard, BT.601, BT.709, BT.2020, and BT.2100 are present. As a numerical value of a standard is larger, a wider color range can be treated. The contrast represents a difference in luminance between the darkest portion and the brightest portion. As the contrast, standards such as SDR (Standard Dynamic Range), HDR (High Dynamic Range), HLG (Hybrid Log-Gamma), and HDR10+ are present. An image has a larger difference in luminance, that is, is clearer in the order of SDR, HDR, and HDR10+. A contrast of HLG is equivalent to a contrast of HDR.

A part or the entire storage device 21 may be provided in an external storage device, an external server, or the like. Some or all of the various information stored in the storage device 21 may be stored in the storage device 21 in advance or may be acquired from the external storage device, the external server, or the like.

The processing device 22 controls an operation of the projector 20. The processing device 22 includes a first processing device 221, a second processing device 222, a third processing device 223, and a fourth processing device 224. Each of the first processing device 221, the second processing device 222, the third processing device 223, and the fourth processing device 224 includes one or more CPUs. However, the first processing device 221, the second processing device 222, the third processing device 223, and the fourth processing device 224 may include a programmable logic device such as an FPGA or an ASIC instead of the CPU or in addition to the CPU.

The first processing device 221 has a function serving as a power supply controller. Power supply control means controlling the power supply device 26. The second processing device 222 has a function serving as a projection controller. Projection control means controlling the projection device 25. The third processing device 223 has a function serving as a communication controller. Communication control means controlling the communication device 23. The fourth processing device 224 has a function serving as an operation controller. Operation control means controlling the operation device 24.

The first processing device 221, the second processing device 222, the third processing device 223, and the fourth processing device 224 are disposed separately from one another. Specifically, for example, the first processing device 221, the second processing device 222, the third processing device 223, and the fourth processing device 224 are respectively implemented as separate chips on one substrate.

The processing device 22 reads the control program 211 from the storage device 21 and executes the read control program 211. The processing device 22 executes the control program 211 to thereby function as a power supply controller, a projection controller, a communication controller, and an operation controller.

The communication device 23 is hardware serving as a transmission and reception device for performing communication with the other devices. The communication device 23 is also called, for example, network device, network controller, network card, or communication module. The communication device 23 may include a connector for wired connection and an interface circuit corresponding to the connector. The communication device 23 may include a wireless communication interface. Examples of the connector for wired connection and the interface circuit include products conforming to HDMI (registered trademark), DisplayPort (registered trademark), wired LAN, IEEE1394, USB, and the like. Examples of the wireless communication interface include products conforming to wireless LAN and Bluetooth (registered trademark). The communication device 23 performs data communication with the computer 10 and the display 30.

The communication device 23 includes a first input/output IF (Interface) 231 and a second input/output IF 232. The first input/output IF 231 includes an input/output connector for wired connection and an interface circuit corresponding to the input/output connector. The second input/output IF 232 includes an input/output connector for wired connection and an interface circuit corresponding to the input/output connector.

The operation device 24 is an input interface that receives, from the user U1, an input operation to the projector 20. The operation device 24 includes, for example, operation buttons provided in a housing of the projector 20. The operation device 24 outputs information for identifying a pressed operation button to the processing device 22. Accordingly, content of the input operation of the user U1 to the operation device 24 is output to the processing device 22. Accordingly, the content of the input operation of the user U1 to the operation device 24 is transmitted to the processing device 22.

The operation device 24 may include a touch panel instead of the operation buttons. In this case, the operation device 24 outputs data indicating a detected touch position to the processing device 22. The operation device 24 may be a remote controller device independent of the housing of the projector 20.

The projection device 25 projects projection light. The projection device 25 includes a not-illustrated light source, a light modulator 251, and a projection lens 252. The light source includes a halogen lamp, a xenon lamp, an ultra-high pressure mercury lamp, an LED, a laser light source, or the like. The light modulator 251 includes one or more liquid crystal panels. The light modulator 251 may include a DMD instead of the liquid crystal panel.

The light modulator 251 modulates, based on a signal input from the second processing device 222, light emitted from the light source into projection light for displaying a projection image on the screen 50. Here, LED is an abbreviation for light emitting diode and DMD is an abbreviation for digital mirror device. The projection lens 252 images the projection light modulated by the light modulator 251 on the screen 50.

The projection device 25 projects the projection light for displaying the projection image onto the screen 50 according to control of the second processing device 222. In other words, the projection device 25 projects an image based on image information input from the processing device 22 onto the screen 50.

The power supply device 26 supplies electric power to the units of the projector 20. The supply or stop of the electric power supplied to the units of the projector 20 is controlled by the first processing device 221.

The first processing device 221 controls the power supply device 26.

The second processing device 222 controls an operation of the projection device 25.

The third processing device 223 controls an operation of the communication device 23. The third processing device 223 detects that the computer 10 has been connected to the first input/output IF 231. The third processing device 223 detects that the display 30 has been connected to the second input/output IF 232.

### 1.5. Configuration of the display

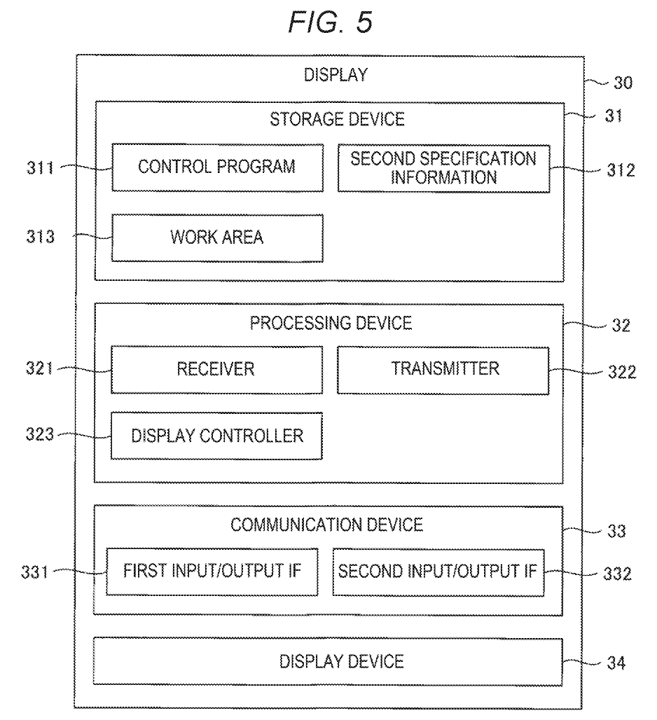

FIG. 5 is a block diagram illustrating a configuration example of the display 30 in FIG. 1. The display 30 includes a storage device 31, a processing device 32, a communication device 33, and a display device 34. The elements provided in the display 30 are connected to one another by a single bus or a plurality of buses for communicating information. The display 30 is an example of an external display apparatus and a second display apparatus.

The storage device 31 stores various information. The storage device 31 includes a volatile memory such as a RAM and a nonvolatile memory such as a ROM. A control program 311, second specification information 312, and the like are stored in the storage device 31. The volatile memory of the storage device 31 is used by the processing device 32 as a work area 313 of the processing device 32. The control program 311 is a program for controlling the entire display 30. The second specification information 312 includes information concerning the resolution, the frame rate, the color depth, the color gamut, and the contrast of the display device 34.

A part or the entire storage device 31 may be provided in an external storage device, an external server, or the like. Some or all of various information stored in the storage device 31 may be stored in the storage device 31 in advance or may be acquired from the external storage device, the external server, or the like.

The processing device 32 controls an operation of the display 30. The processing device 32 has functions serving as a receiver 321, a transmitter 322, and a display controller 323. The processing device 32 includes one or more CPUs. However, the processing device 32 may include a programmable logic device such as an FPGA or an ASIC instead of the CPU or in addition to the CPU.

The processing device 32 reads the control program 311 from the storage device 31 and executes the read control program 311. The processing device 32 executes the control program 311 to thereby function as the receiver 321, the transmitter 322, and the display controller 323.

The receiver 321 receives the image data 112 from the projector 20 via the communication device 33.

The transmitter 322 transmits various information to the projector 20 via the communication device 33.

The display controller 323 displays the acquired image data 112 on the display device 34.

The communication device 33 is hardware serving as a transmission and reception device for performing communication with the other devices. The communication device 33 is also called, for example, network device, network controller, network card, or communication module. The communication device 33 may include a connector for wired connection and an interface circuit corresponding to the connector. The communication device 33 may include a wireless communication interface. Examples of the connector for wired connection and the interface circuit include products conforming to HDMI (registered trademark), DisplayPort (registered trademark), wired LAN, IEEE1394, USB, and the like. Examples of the wireless communication interface include products conforming to wireless LAN and Bluetooth (registered trademark). The communication device 33 performs data communication with the projector 20. In the present embodiment, HDMI (registered trademark) is explained as an example of the communication interface.

The display device 34 is a device that displays an image and character information. The display device 34 displays various images based on control of the processing device 32. For example, various display panels such as a liquid crystal display panel and an organic EL (Electro Luminescence) display panel are suitably used as the display device 34.

The display 30 may include an input device for adjusting an image to be displayed on the display device 34.

### 1.6. Specific operation in the image display system 1

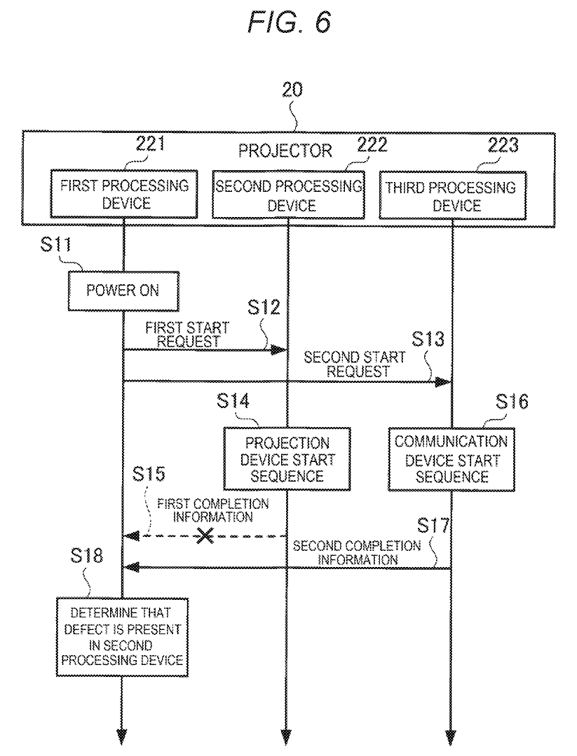

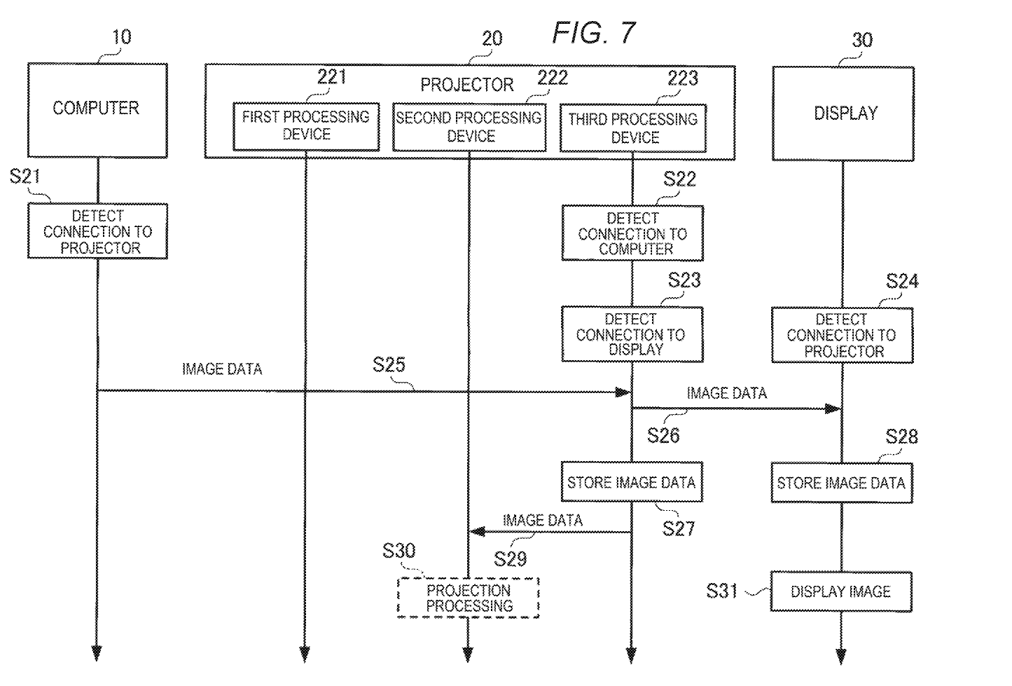

Next, specific operations in the projector 20 or the image display system 1 are explained with reference to FIGS. 6 and 7. In the first embodiment, explanation is based on the premise that specification information concerning the projection device 25 and specification information concerning the display device 34 are the same.

### 1.6.1. Power supply start operation of the projector 20

FIG. 6 is a sequence chart illustrating a power supply start operation of the projector 20 illustrated in FIG. 1. The operation device 24 of the projector 20 receives power supply start operation from the user U1. The power supply start operation is an operation of the user U1 pressing a power-on button of the operation device 24.

When the power supply start operation by the user U1 is received in step S11, the first processing device 221 outputs a first start request to the second processing device 222 in step S12 and outputs a second start request to the third processing device 223 in step S13.

Subsequently, in step S14, the second processing device 222 executes a projection device start sequence for starting the projection device 25.

In step S15, the second processing device 222 outputs first completion information to the first processing device 221. However, in the present embodiment, a part of wiring of the second processing device 222 is disconnected and the first completion information cannot be output. Therefore, the first processing device 221 cannot receive the first completion information.

In step S16, the third processing device 223 executes a communication device start sequence for starting the communication device 23.

In step S17, the third processing device 223 outputs second completion information to the first processing device 221.

In step S18, when the first processing device 221 cannot acquire the first completion information even when a predetermined time has elapsed after the first start request was output, the first processing device 221 determines that there is a defect in the second processing device 222.

### 1.6.2. Image data output operation in the image display system 1

FIG. 7 is a sequence chart illustrating an image data output operation of the image display system 1 illustrated in FIG. 1. In this example, as illustrated in FIG. 1, the computer 10 and the projector 20 are connected to each other by the first communication cable 41, and the projector 20 and the display 30 are connected to each other by the second communication cable 42. This example is based on the premise that all of starts of the computer 10, the projector 20, and the display 30 have been completed.

In step S21, the processing device 12 of the computer 10 detects that the projector 20 has been connected to the second input/output IF 132 via the first communication cable 41.

In step S22, the third processing device 223 of the projector 20 detects that the computer 10 has been connected to the first input/output IF 231 via the first communication cable 41.

In step S23, the third processing device 223 detects that the display 30 has been connected to the second input/output IF 232 via the second communication cable 42.

In step S24, the processing device 32 of the display 30 detects that the projector 20 has been connected to the first input/output IF 331 via the second communication cable 42.

In step S25, the processing device 12 outputs the image data 112, stored in the storage device 11, from the second input/output IF 132.

In step S26, the third processing device 223 outputs the image data 112 acquired from the first input/output IF 231 to the display 30.

In step S27, the third processing device 223 stores the acquired image data 112 in the storage device 21.

In step S28, the processing device 32 stores the image data 112 acquired from the first input/output IF 331 in the storage device 31.

In step S29, the third processing device 223 outputs the image data 112 to the second processing device 222. However, a defect has occurred in the second processing device 222. If no defect has occurred in the second processing device 222, in step S30, the second processing device 222 executes projection processing by the projection device 25. However, in this example, the processing in step S30 is not executed.

In step S31, the processing device 32 displays an image based on the image data 112 on the display device 34.

### 1.7. Effects achieved by the first embodiment

As explained above, the projector 20 according to the first embodiment includes the projection device 25, the power supply device 26, the communication device 23, the first processing device 221, the second processing device 222, and the third processing device 223. The communication device 23 includes the first input/output IF 231 and the second input/output IF 232.

The first processing device 221 controls the power supply device 26. The second processing device 222 controls the projection device 25. The second processing device 222 is different from the first processing device 221. The third processing device 223 controls the communication device 23. The third processing device 223 is different from both of the first processing device 221 and the second processing device 222.

The third processing device 223 executes detecting that the computer 10 that outputs the image data 112 has been connected to the first input/output IF 231, acquiring the image data 112 output by the computer 10, and outputting the image data 112 from the second input/output IF 232 to the display 30.

According to the aspect, the first processing device 221 that controls the power supply device 26, the second processing device 222 that controls the projection device 25, and the third processing device 223 that controls the communication device 23 are provided in the projector 20 independently of one another. Therefore, even if a defect has occurred in the second processing device 222, since the image data 112 can be output to the display 30 by the third processing device 223, it is possible to prevent the influence of the defect in the projector 20 from spreading to the display 30.

The first processing device 221, the second processing device 222, and the third processing device 223 are disposed separately from one another.

According to this aspect, even if any one of the first processing device 221, the second processing device 222, and the third processing device 223 has failed, the processing devices are less easily affected by the failure.

In the present embodiment, the image display system 1 is a system used by a school teacher in a classroom for student guidance. However, a use of the image display system 1 is not limited thereto. In the present embodiment, one projector and one display are combined. However, a projector may be used instead of the display or a display may be used instead of the projector.

In the present embodiment, HDMI (registered trademark) is used as a daisy chain communication interface. However, a communication interface capable of performing communication in a daisy chain such as DisplayPort (registered trademark) or IEEE1394 may be used.

### 2. Modifications

The present disclosure is not limited to the embodiment explained above, and various modifications can be adopted within the scope of the present disclosure. Specific aspects of the modifications are exemplified below. Two or more aspects optionally selected from the following exemplification can be combined as appropriate within a range in which the aspects do not contradict one another. In the modifications exemplified below, the reference numerals and signs used in the above explanation are used for elements having action and functions equivalent to those in the embodiment explained above, and detailed explanation of the elements is omitted as appropriate.

### 2.1. Modification 1

In the embodiment explained above, the aspect in which the projection control is not performed because of the failure of the second processing device 222 is exemplified. However, in the embodiment explained above, the electric power from the power supply device 26 is continuously supplied to the second processing device 222 and the projection device 25. In contrast, in a modification 1, the supply of electric power from the power supply device 26 to the failed second processing device 222 and the projection device 25 that is uncontrollable because the second processing device 222 has failed is stopped.

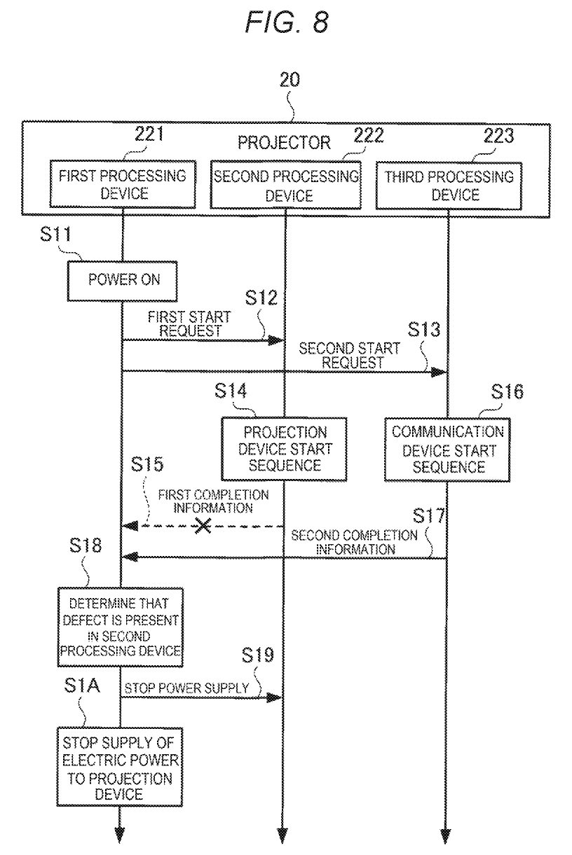

FIG. 8 is a sequence chart illustrating a power supply start operation of the projector 20 according to the modification 1. In FIG. 8, the same steps as the steps in FIG. 6 are denoted by the same step numbers as the step number in FIG. 6. The operation device 24 of the projector 20 receives a power supply start operation from the user U1.

When the power supply start operation by the user U1 is received in step S11, the first processing device 221 outputs a first start request to the second processing device 222 in step S12 and outputs a second start request to the third processing device 223 in step S13.

Subsequently, in step S14, the second processing device 222 executes a projection device start sequence for starting the projection device 25.

In step S15, the second processing device 222 outputs first completion information to the first processing device 221. However, in the present embodiment, a part of wiring of the second processing device 222 is disconnected and the first completion information cannot be output. Therefore, the first processing device 221 cannot receive the first completion information.

In step S16, the third processing device 223 executes a communication device start sequence for starting the communication device 23.

In step S17, the third processing device 223 outputs second completion information to the first processing device 221.

In step S18, when the first processing device 221 cannot acquire the first completion information even when a predetermined time has elapsed after the first start request was output, the first processing device 221 determines that there is a defect in the second processing device 222.

In step S19, the first processing device 221 stops the supply of electric power to the second processing device 222.

In step S1A, the first processing device 221 stops the supply of electric power to the projection device 25.

In the projector 20 according to the modification 1, when projection of an image based on image data by the projection device 25 is disabled, the first processing device 221 causes the power supply device 26 to stop the supply of electric power to the projection device 25 and causes the power supply device 26 to maintain the supply of electric power to the third processing device 223 and the communication device 23.

According to this aspect, when a defect has occurred in the second processing device 222, by supplying electric power to the communication device 23 and the third processing device 223 and stopping the supply of electric power to the projection device 25, it is possible to output the image data 112 to the display 30 while reducing electric power wastefully consumed in the projection device 25 and the second processing device 222.

### 2.2. Modification 2

The first embodiment is based on the premise that the specification information concerning the projection device 25 and the specification information concerning the display device 34 are the same. In a modification 2, when the specification information concerning the projection device 25 and the specification information concerning the display device 34 are different from each other, the computer 10, which is the source equipment, needs to output image data according to the respective specification information. In the modification 2, an example in which the computer 10 determines, according to specification information, a format of image data to be output is explained.

The projector 20 plays a role of relaying, to the display 30, the image data 112 output from the computer 10. The projector 20 plays a role of relaying the second specification information 312 of the display 30 to the computer 10.

The third processing device 223 detects that the display 30 has been connected to the second input/output IF 232. The third processing device 223 acquires, via the second communication cable 42, the second specification information 312 output by the display 30. The third processing device 223 outputs the acquired second specification information 312 to the computer 10 via the first communication cable 41. The image data 112 is generated based on the first specification information 212 and the second specification information 312 in the computer 10.

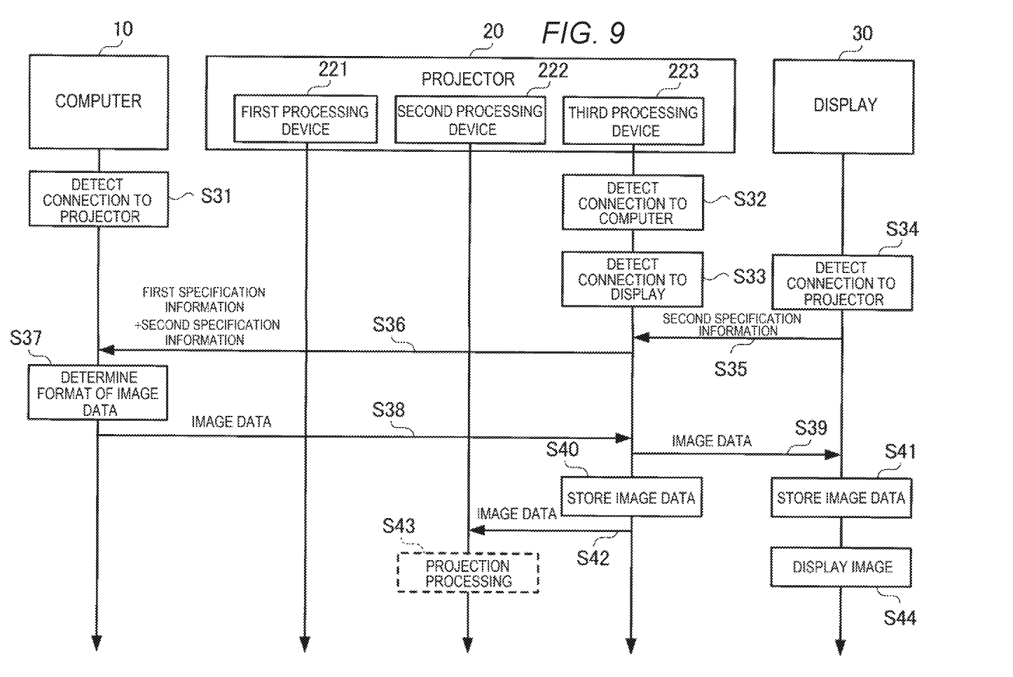

FIG. 9 is a sequence chart illustrating an image data output operation of the image display system 1 according to the modification 2. This modification is based on the premise that all of starts of the computer 10, the projector 20, and the display 30 have been completed.

In step S31, the processing device 12 of the computer 10 detects that the projector 20 has been connected to the second input/output IF 132 via the first communication cable 41.

In step S32, the third processing device 223 of the projector 20 detects that the computer 10 has been connected to the first input/output IF 231 via the first communication cable 41.

In step S33, the third processing device 223 detects that the display 30 has been connected to the second input/output IF 232 via the second communication cable 42.

In step S34, the processing device 32 of the display 30 detects that the projector 20 has been connected to the first input/output IF 331 via the second communication cable 42.

In step S35, the processing device 32 outputs the second specification information 312 stored in the storage device 31 to the projector 20.

In step S36, the third processing device 233 outputs the first specification information 212 and the second specification information 312 stored in the storage device 21 to the computer 10.

In step S37, the processing device 12 determines, based on the first specification information 212 and the second specification information 312, a format of the image data 112 stored in the storage device 11. Specifically, the processing device 12 determines the format of the image data 112 according to lower order specifications of specifications included in the first specification information 212 and specifications included in the second specification information 312. Here, the lower order specifications are specifications in which resolution is relatively low, specifications in which a frame rate is relatively low, specifications in which a color depth is relatively small, specifications in which a color gamut is relatively narrow, specifications in which contrast is relatively low, or the like.

In step S38, the processing device 12 outputs the image data 112, the format of which has been determined, to the projector 20.

In step S39, the third processing device 223 outputs the image data 112 acquired from the first input/output IF 231 to the display 30.

In step S40, the third processing device 223 stores the acquired image data 112 in the storage device 21.

In step S41, the processing device 32 stores the acquired image data 112 in the storage device 31.

In step S42, the third processing device 233 outputs the image data 112 stored in the storage device 21 to the second processing device 222. However, a defect has occurred in the second processing device 222. If no defect has occurred in the second processing device 222, the second processing device 222 executes the projection processing by the projection device 25 in step S43. However, in this example, the processing in step S43 is not executed.

In step S44, the processing device 32 displays an image based on the image data 112 on the display device 34.

As explained above, the third processing device 223 executes detecting that the display 30 has been connected to the second input/output IF 232, acquiring the second specification information 312 output by the display 30, and outputting the acquired second specification information 312 to the computer 10. A format of the image data 112 is determined based on the first specification information 212 and the second specification information 312.

According to this aspect, by acquiring, from the computer 10, image data determined based on specification information acquired from the display 30, it is possible to output image data matching the specifications of the display 30 to the display 30.

As explained above, the image display system 1 according to the modification 2 includes the computer 10, the projector 20 connected to the computer 10, and the display 30 connected to the projector 20. The display 30 outputs the second specification information 312 concerning display of an image by the display 30 to the projector 20. The projector 20 outputs the first specification information 212 and the second specification information 312 concerning display of an image by the projector 20 to the computer 10. The computer 10 determines, based on the first specification information 212 and the second specification information 312, a format of specification information displayable by the projector 20 and the display 30 and outputs image data in the determined format to the projector 20. The projector 20 outputs image data to the display 30.

According to this aspect, image data matching the specifications of the image display apparatus and the external display apparatus, which are sink equipment, is automatically selected and output from the source equipment. Therefore, it is possible to improve the convenience for the user.

When the first specification information 212 and the second specification information 312 are different from each other, the computer 10 determines a format of the image data 112 according to lower order specifications of the specifications included in the first specification information 212 and the specifications included in the second specification information 312.

According to this aspect, since a format of image data is adjusted to lower order specifications, both of the projector 20 and the display 30 are capable of more securely projecting and displaying images.

### 2.3. Modification 3

In the modification 2, the aspect in which the computer 10 determines the format of the image data based on the first specification information 212 and the second specification information 312 is explained. However, the format of the image data may be determined in the projector 20.

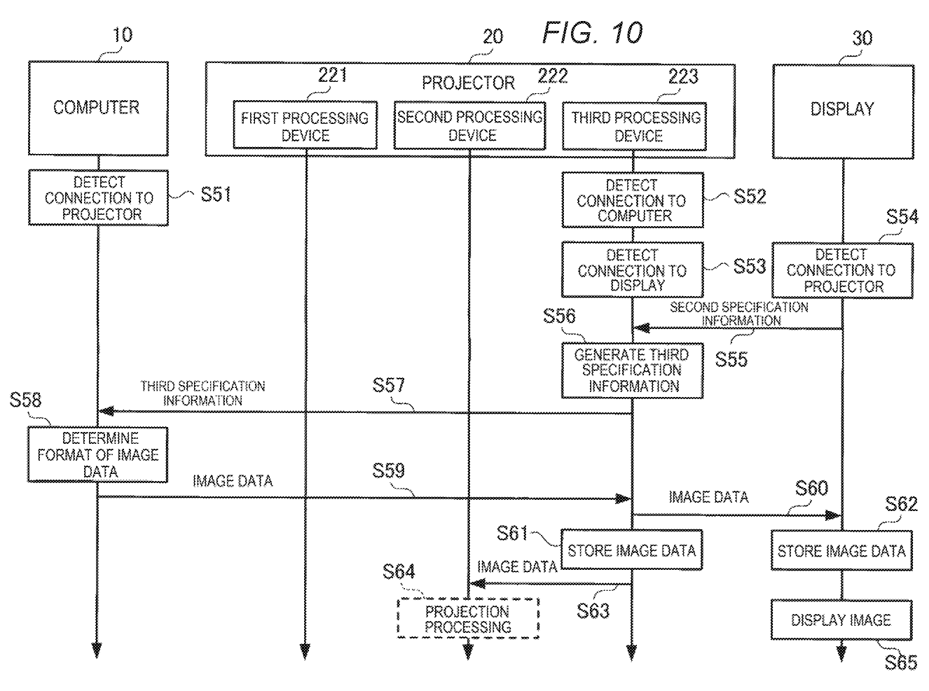

FIG. 10 is a sequence chart illustrating an image data output operation of the image display system 1 according to a modification 3. This modification is based on the premise that all of starts of the computer 10, the projector 20, and the display 30 have been completed.

In step S51, the processing device 12 of the computer 10 detects that the projector 20 has been connected to the second input/output IF 132 via the first communication cable 41.

In step S52, the third processing device 223 of the projector 20 detects that the computer 10 has been connected to the first input/output IF 231 via the first communication cable 41.

In step S53, the third processing device 223 detects that the display 30 has been connected to the second input/output IF 232 via the second communication cable 42.

In step S54, the processing device 32 of the display 30 detects that the projector 20 has been connected to the first input/output IF 331 via the second communication cable 42.

In step S55, the processing device 32 outputs the second specification information 312 stored in the storage device 31 to the projector 20.

In step S56, the third processing device 233 determines third specification information based on the first specification information 212 stored in the storage device 21 and the second specification information 312. The third specification information is specification information in which lower order specifications of the specifications included in the first specification information and the specifications included in the second specification information are selected.

In step S57, the third processing device 233 outputs the third specification information to the computer 10.

In step S58, the processing device 12 determines a format of the image data 112 displayable by the projector 20 and the display 30, based on the third specification information.

In step S59, the processing device 12 outputs the image data 112, the format of which has been determined, to the projector 20.

In step S60, the third processing device 223 outputs the image data 112 acquired from the first input/output IF 231 to the display 30.

In step S61, the third processing device 223 stores the acquired image data 112 in the storage device 21.

In step S62, the processing device 32 stores the acquired image data 112 in the storage device 31.

In step S63, the third processing device 233 outputs the image data 112 stored in the storage device 21 to the second processing device 222. However, a defect has occurred in the second processing device 222. If no defect has occurred in the second processing device 222, the second processing device 222 executes the projection processing by the projection device 25 in step S64. However, in this example, the processing in step S64 is not executed.

In step S65, the processing device 32 displays an image based on the image data 112 on the display device 34.

As explained above, the image display system 1 according to the modification 3 includes the computer 10, the projector 20 connected to the computer 10, and the display 30 connected to the projector 20. The display 30 outputs the second specification information 312 concerning display of an image by the display 30 to the projector 20. The projector 20 generates third specification information based on the first specification information 212 concerning display of an image by the projector 20 and the second specification information 312 and outputs the third specification information to the computer 10. The computer 10 determines, based on the third specification information, a format of specification information displayable by the projector 20 and the display 30 and outputs the image data 112 based on the third specification information to the projector 20. The projector 20 outputs the image data 112 based on the third specification information to the display 30.

According to this aspect, image data matching the specifications of the image display apparatus and the external display apparatus, which are sink equipment, is automatically selected and output from the source equipment. Therefore, it is possible to improve the convenience for the user.

When the first specification information 212 and the second specification information 312 are different from each other, the projector 20 generates the third specification information in which the lower order specifications of the specifications included in the first specification information 212 and the specifications included in the second specification information 312 are selected. The computer 10 determines a format of the image data 112 based on the third specification information.

According to this aspect, since a format of image data is adjusted to lower order specifications, both of the projector 20 and the display 30 are capable of more securely projecting and displaying images.

### 2.4. Modification 4

In the first embodiment, when a defect has occurred in the second processing device 222 and projection of an image is disabled in the projection device 25, the user U1 may operate the operation device 24 to stop the supply of electric power to the projection device 25. The supply of electric power to the projection device 25 is stopped, for example, by pressing a sleep button of the operation device 24.

### 3. Appendixes

Hereinafter, a summary of the present disclosure is appended below.

### 3.1. Appendix 1

An image display apparatus including: a projection device; a power supply device; a communication device including a first interface and a second interface; a first control circuit configured to control the power supply device; a second control circuit configured to control the projection device, the second control circuit being different from the first control circuit; and a third control circuit configured to control the communication device, the third control circuit being different from the first control circuit and the second control circuit, wherein the third control circuit executes: detecting that an image output apparatus that outputs image data was connected to the first interface; acquiring the image data output by the image output apparatus; and outputting the image data from the second interface to an external display apparatus.

With the image display apparatus described in Appendix 1, the first control circuit that controls the power supply device, the second control circuit that controls the projection device, and the third control circuit that controls the communication device are provided in the image display apparatus independently of one another. Therefore, even if a defect has occurred in the second control circuit, since the image data can be output to the external display apparatus by the third control circuit, it is possible to prevent the influence of the defect in the image display apparatus from spreading to the external display apparatus.

### 3.2. Appendix 2

An image display apparatus described in Appendix 2 is the image display apparatus described in Appendix 1, wherein, when projection of an image based on the image data by the projection device is disabled, the first control circuit causes the power supply device to stop supply of electric power to the projection device and causes the power supply device to maintain supply of electric power to the third control circuit and the communication device.

With the image display apparatus described in Appendix 2, when a defect has occurred in the second control circuit, by supplying electric power to the communication device and the third control circuit and stopping the supply of electric power to the projection device, it is possible to output the image data to the external display apparatus while reducing electric power wastefully consumed in the projection device and the second control circuit.

### 3.3. Appendix 3

An image display apparatus described in Appendix 3 is the image display apparatus described in Appendix 1 or 2, wherein the third control circuit executes: detecting that the external display apparatus was connected to the second interface; acquiring specification information output by the external display apparatus; and outputting the acquired specification information to the image output apparatus, and a format of the image data is determined based on the specification information.

With the image display apparatus according to Appendix 3, by acquiring, from the image output apparatus, the image data determined based on the specification information acquired from the external display apparatus, it is possible to output image data matching the specifications of the external display apparatus to the external display apparatus.

### 3.4. Appendix 4

An image display apparatus described in Appendix 4 is the image display apparatus described in any one of Appendixes 1 to 3, wherein the first control circuit, the second control circuit, and the third control circuit are individually disposed.

With the image display apparatus described in Appendix 4, even if any one of the first control device, the second control device, and the third control device has failed, the control devices are less easily affected by the failure.

### 3.5. Appendix 5

An image display system including: source equipment; a first display apparatus connected to the source equipment; and a second display apparatus connected to the first display apparatus, wherein the second display apparatus outputs second specification information concerning display of an image by the second display apparatus to the first display apparatus, the first display apparatus outputs first specification information concerning display of an image by the first display apparatus and the second specification information to the source equipment, the source equipment determines, based on the first specification information and the second specification information, a format of image data displayable by the first display apparatus and the second display apparatus and outputs the image data in the determined format to the first display apparatus, and the first display apparatus outputs the image data to the second display apparatus.

With the image display system described in Appendix 5, image data matching the specifications of the image display apparatus and the external display apparatus, which are sink devices, is automatically selected and output from the source equipment. Therefore, it is possible to improve the convenience for the user.

### 3.6. Appendix 6

An image display system described in Appendix 6 is the image display system described in Appendix 5, wherein, when the first specification information and the second specification information are different from each other, the source equipment determines the format of the image data according to lower order specifications of specifications included in the first specification information and specifications included in the second specification information.

With the image display system described in Appendix 6, since the format of the image data is adjusted to the lower order specifications, both of the image display apparatus and the external display apparatus are capable of more securely projecting and displaying images.

### 3.7. Appendix 7

An image display system including: source equipment; a first display apparatus connected to the source equipment, and a second display apparatus connected to the first display apparatus, wherein the second display apparatus outputs second specification information concerning display of an image by the second display apparatus to the first display apparatus, the first display apparatus generates third specification information based on first specification information concerning display of an image by the first display apparatus and the second specification information and outputs the third specification information to the source equipment, the source equipment determines, based on the third specification information, a format of image data displayable by the first display apparatus and the second display apparatus and outputs image data based on the third specification information to the first display apparatus, and the first display apparatus outputs the image data based on the third specification information to the second display apparatus.

With the image display system described in Appendix 7, image data matching the specifications of the image display apparatus and the external display apparatus, which are sink devices, is automatically selected and output from the source equipment. Therefore, it is possible to improve the convenience for the user.

### 3.8. Appendix 8

An image display system described in Appendix 8 in the image display system described in Appendix 7, wherein, when the first specification information and the second specification information are different from each other, the first display apparatus selects lower order specifications of specifications included in the first specification information and specifications included in the second specification information to generate the third specification information.

With the image display system described in Appendix 8, since the format of the image data is adjusted to the lower order specifications, both of the image display apparatus and the external display apparatus are capable of more securely projecting and displaying images.

What is claimed is:

1. An image display apparatus comprising:
a projection device;
a power supply device;
a communication device including a first interface and a second interface;
a first control circuit configured to control the power supply device;
a second control circuit configured to control the projection device, the second control circuit being different from the first control circuit; and
a third control circuit configured to control the communication device, the third control circuit being different from the first control circuit and the second control circuit, wherein
the third control circuit executes:
detecting that an image output apparatus that outputs image data was connected to the first interface;
acquiring the image data output by the image output apparatus; and
outputting the image data from the second interface to an external display apparatus.

2. The image display apparatus according to claim 1, wherein, when projection of an image based on the image data by the projection device is disabled, the first control circuit causes the power supply device to stop supply of electric power to the projection device and causes the power supply device to maintain supply of electric power to the third control circuit and the communication device.

3. The image display apparatus according to claim 1, wherein
the third control circuit executes:
detecting that the external display apparatus was connected to the second interface;
acquiring specification information output by the external display apparatus; and
outputting the acquired specification information to the image output apparatus, and
a format of the image data is determined based on the specification information.

4. The image display apparatus according to claim 1, wherein the first control circuit, the second control circuit, and the third control circuit are individually disposed.

5. An image display system comprising:
source equipment;
a first display apparatus connected to the source equipment; and
a second display apparatus connected to the first display apparatus, wherein
the second display apparatus outputs second specification information concerning display of an image by the second display apparatus to the first display apparatus,
the first display apparatus outputs first specification information concerning display of an image by the first display apparatus and the second specification information to the source equipment,
the source equipment determines, based on the first specification information and the second specification information, a format of image data displayable by the first display apparatus and the second display apparatus, and outputs the image data in the determined format to the first display apparatus, and
the first display apparatus outputs the image data to the second display apparatus.

6. The image display system according to claim 5, wherein, when the first specification information and the second specification information are different from each other, the source equipment determines the format of the image data according to lower order specifications of specifications included in the first specification information and specifications included in the second specification information.

7. An image display system comprising:
source equipment;
a first display apparatus connected to the source equipment, and
a second display apparatus connected to the first display apparatus, wherein
the second display apparatus outputs second specification information concerning display of an image by the second display apparatus to the first display apparatus,
the first display apparatus generates third specification information based on first specification information concerning display of an image by the first display apparatus and the second specification information and outputs the third specification information to the source equipment,
the source equipment determines, based on the third specification information, a format of image data displayable by the first display apparatus and the second display apparatus and outputs image data based on the third specification information to the first display apparatus, and
the first display apparatus outputs the image data based on the third specification information to the second display apparatus.

8. The image display system according to claim 7, wherein, when the first specification information and the second specification information are different from each other, the first display apparatus selects lower order specifications of specifications included in the first specification information and specifications included in the second specification information to generate the third specification information.
